(19) United States
(12) Patent Application Publication
(10) Pub. No.: US 2017/0118321 A1
(43) Pub. Date: Apr. 27, 2017

(54) AUGMENTED PERSONAL DEVICE USER INTERFACE AND NOTIFICATION

(71) Applicant: Ford Global Technologies, LLC, Dearborn, MI (US)

(72) Inventors: Pietro Buttolo, Dearborn Heights, MI (US); Stephen Ronald Tokish, Sylvania, OH (US); James Stewart Rankin, II, Novi, MI (US); Stuart C. Salter, White Lake, MI (US)

(21) Appl. No.: 14/920,456

(22) Filed: Oct. 22, 2015

(51) Int. Cl. H04M 1/60; H04M 1/725; H04W 12/08

(52) U.S. Cl. CPC H04M 1/6091; H04W 12/08; H04M 1/72572

(57) ABSTRACT

A memory of a personal device may store preferences of a user. A processor of the personal device may be programmed to scan, using a wireless transceiver, for in-vehicle components located within a seating zone of a vehicle in which the personal device is located, identify features of the in-vehicle components, and provide feedback to the user of a notification, using at least one of the in-vehicle components, based on the preferences and features of the in-vehicle components. An in-vehicle component may identify a user request to invoke an augmented user interface for a personal device located in a seating zone of a vehicle; activate a vehicle component interface application of the personal device responsive to the user request; and send, to the vehicle component interface application, address information and authentication information of in-vehicle components in the seating zone providing the augmented user interface to the vehicle component interface application.

### TECHNICAL FIELD

Aspects of the disclosure generally relate to augmenting a user interface of a personal device using in-vehicle components.

### BACKGROUND

Sales of personal devices, such as smartphones and wearables, continue to increase. Thus, more personal devices are brought by users into the automotive context. Smartphones can already be used in some vehicle models to access a wide range of vehicle information, to start the vehicle, and to open windows and doors. Some wearables are capable of providing real-time navigation information to the driver. Device manufacturers are implementing frameworks to enable a more seamless integration of their brand of personal devices into the driving experience.

### SUMMARY

In a first illustrative embodiment, a system includes a personal device including a wireless transceiver; a memory storing preferences of a user; and a processor, programmed to scan, using the transceiver, for in-vehicle components of a seating zone of a vehicle in which the personal device is located, identify available features of the in-vehicle components, and provide feedback to the user of a notification, using at least one of the in-vehicle components, based on the preferences and the available features.

In a second illustrative embodiment, a method includes identifying, by a credential sharing in-vehicle component, a user request to invoke an augmented user interface for a personal device located in a seating zone of a vehicle; activating a component interface application of the personal device responsive to the user request; and sending, to the component interface application, address information and authentication information of in-vehicle components in the seating zone providing the augmented user interface to the component interface application.

In a third illustrative embodiment, a non-transitory computer-readable medium embodies instructions that, when executed by a processor of a personal device, cause the personal device to receive, responsive to a connection information request, credentials required for access to in-vehicle components located within a seating zone of a vehicle in which the personal device is located, the in-vehicle components providing an augmented user interface to the personal device; connect to display, speaker, and hotspot in-vehicle components of the seating zone using information included in the credentials; and use the in-vehicle components providing the augmented user interface to send feedback to a user of a notification.

### BRIEF DESCRIPTION OF THE DRAWINGS

FIG. 1A illustrates an example system including a vehicle having a mesh of in-vehicle components configured to locate and interact with users and personal devices of the users;

FIG. 1B illustrates an example in-vehicle component equipped with a wireless transceiver configured to facilitate detection of and identify proximity of the personal devices;

FIG. 1C illustrates an example in-vehicle component requesting signal strength from other in-vehicle components of the vehicle;

FIG. 2 illustrates an example user interface of the vehicle component interface application illustrating in-vehicle components detected by the personal device;

FIG. 3 illustrates an example diagram including a passenger traveling in a back seat of the vehicle having a personal device;

FIG. 4 illustrates an example diagram illustrating a notification being provided to the passenger traveling in the back seat of the vehicle having the personal device;

FIG. 5 illustrates an example diagram of an automated connection and augmenting of the user interface of personal devices using the in-vehicle components available in the vehicle interior;

FIG. 6 illustrates an example process for automatic credential sharing of information for connection of the personal device to augmented user interface in-vehicle components; and

FIG. 7 illustrates an example process for enabling the augmented user interface in-vehicle components with the personal device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle interior modules, such as reading lights or speakers, may be enhanced with a wireless communication interface such as Bluetooth Low Energy (BLE). These enhanced modules of the vehicle interior may be referred to as in-vehicle components. Vehicle occupants may utilize their personal devices to control features of the in-vehicle components over the communications interface. In an example, a vehicle occupant may utilize an application installed to the personal device to turn a reading light on or off or to adjust a volume of a speaker.

The location of the personal device within the vehicle cabin may be determined according to signal strength information between the in-vehicle components and the personal device. Based on the location, the personal device may identify what in-vehicle component features are available in the specific seating location of the user, as well as how to interact with the identified features. Accordingly, the personal device of the user may become an extension of the vehicle user interface.

Conversely, the in-vehicle components may also become an extension of the user interface of the personal device. When the personal device of a user is detected as having entered a seating position of the vehicle, in-vehicle components within the seating position may by automatically connected to the personal device. These in-vehicle components may serve to provide the personal device with an augmented user interface. As some examples, the connected in-vehicle components may include input devices such as keyboards or trackpads, as well as output devices such as displays or speakers. The augmented user interface may accordingly provide for an improved user experience for active operation of the personal device within the vehicle cabin. Moreover, to aid in informing the user of incoming communications or meetings, the personal device may route calls, texts or other notifications or events to the in-vehicle components of the zone in which the personal device is located.

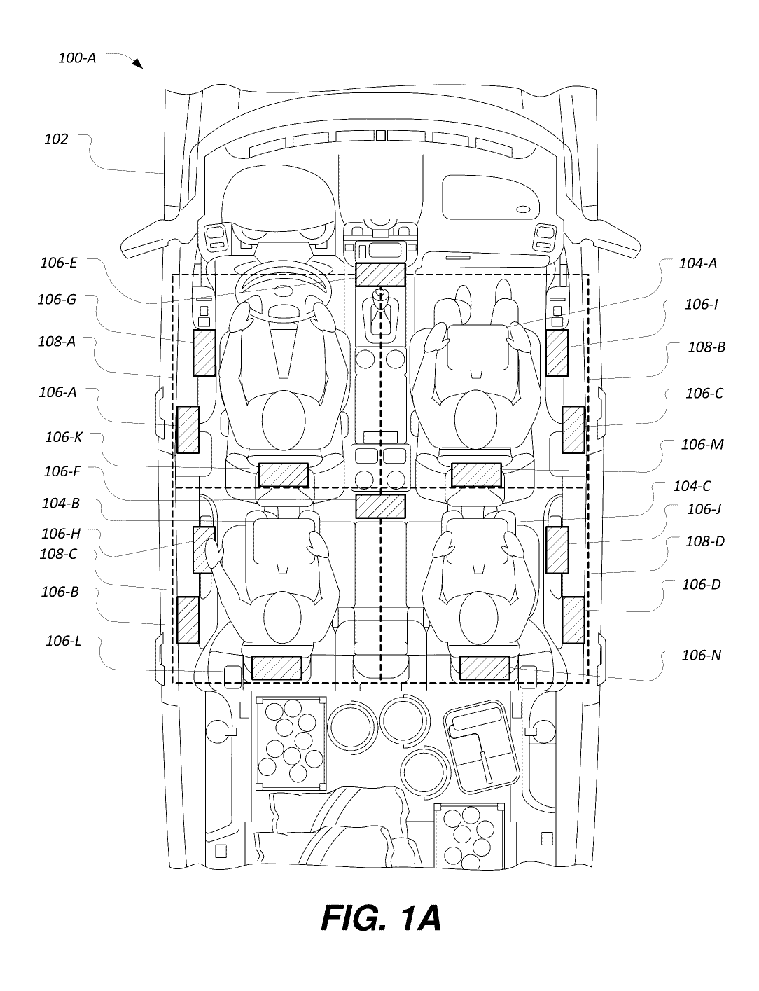

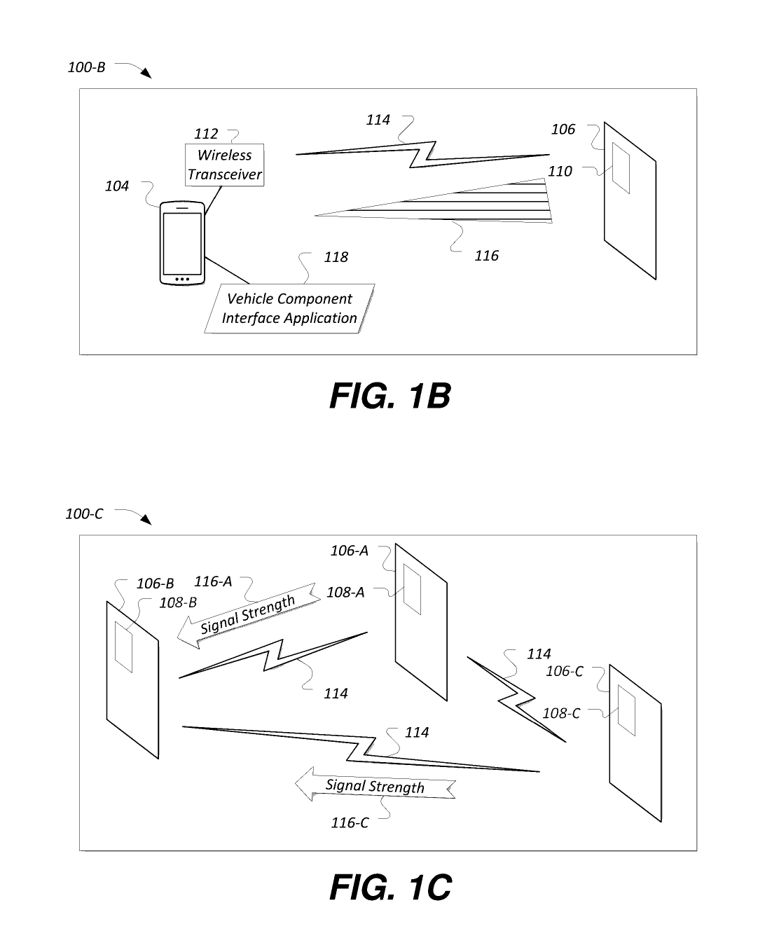

FIG. 1A illustrates an example system 100 including a vehicle 102 having a mesh of in-vehicle components 106 configured to locate and interact with users and personal devices 104 of the users. The system 100 may be configured to allow the users, such as vehicle occupants, to seamlessly interact with the in-vehicle components 106 in the vehicle 102 or with any other framework-enabled vehicle 102. Moreover, the interaction may be performed without requiring the personal devices 104 to have been paired with or be in communication with a head unit or other centralized computing platform of the vehicle 102.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The personal devices 104-A, 104-B and 104-C (collectively 104) may include mobile devices of the users, and/or wearable devices of the users. The mobile devices may be any of various types of portable computing device, such as cellular phones, tablet computers, smart watches, laptop computers, portable music players, or other devices capable of networked communication with other mobile devices. The wearable devices may include, as some non-limiting examples, smartwatches, smart glasses, fitness bands, control rings, or other personal mobility or accessory device designed to be worn and to communicate with the user's mobile device.

The in-vehicle components 106-A through 106-N (collectively 106) may include various elements of the vehicle 102 having user-configurable settings. These in-vehicle components 106 may include, as some examples, overhead light in-vehicle components 106-A through 106-D, climate control in-vehicle components 106-E and 106-F, seat control in-vehicle components 106-G through 106-J, and speaker in-vehicle components 106-K through 106-N. Other examples of in-vehicle components 106 are possible as well, such as rear seat entertainment screens or automated window shades. In many cases, the in-vehicle component 106 may expose controls such as buttons, sliders, and touchscreens that may be used by the user to configure the particular settings of the in-vehicle component 106. As some possibilities, the controls of the in-vehicle component 106 may allow the user to set a lighting level of a light control, set a temperature of a climate control, set a volume and source of audio for a speaker, and set a position of a seat.

The vehicle 102 interior may be divided into multiple zones 108, where each zone 108 may be associated with a seating position within the vehicle 102 interior. For instance, the front row of the illustrated vehicle 102 may include a first zone 108-A associated with the driver seating position, and a second zone 108-B associated with a front passenger seating position. The second row of the illustrated vehicle 102 may include a third zone 108-C associated with a driver-side rear seating position and a fourth zone 108-D associated with a passenger-side rear seating position. Variations on the number and arrangement of zones 108 are possible. For instance, an alternate second row may include an additional fifth zone 108 of a second-row middle seating position (not shown). Four occupants are illustrated as being inside the example vehicle 102, three of whom are using personal devices 104. A driver occupant in the zone 108-A is not using a personal device 104. A front passenger occupant in the zone 108-B is using the personal device 104-A. A rear driver-side passenger occupant in the zone 108-C is using the personal device 104-B. A rear passenger-side passenger occupant in the zone 108-D is using the personal device 104-C.

Each of the various in-vehicle components 106 present in the vehicle 102 interior may be associated with the one or more of the zones 108. As some examples, the in-vehicle components 106 may be associated with the zone 108 in which the respective in-vehicle component 106 is located and/or the one (or more) of the zones 108 that is controlled by the respective in-vehicle component 106. For instance, the light in-vehicle component 106-C accessible by the front passenger may be associated with the second zone 108-B, while the light in-vehicle component 106-D accessible by passenger-side rear may be associated with the fourth zone 108-D. It should be noted that the illustrated portion of the vehicle 102 in FIG. 1A is merely an example, and more, fewer, and/or differently located in-vehicle components 106 and zones 108 may be used.

Referring to FIG. 1B, each in-vehicle component 106 may be equipped with a wireless transceiver 110 configured to facilitate detection of and identify proximity of the personal devices 104. In an example, the wireless transceiver 110 may include a wireless device, such as a Bluetooth Low Energy transceiver configured to enable low energy Bluetooth signal intensity as a locator, to determine the proximity of the personal devices 104. Detection of proximity of the personal device 104 by the wireless transceiver 110 may, in an example, cause a vehicle component interface application 118 of the detected personal device 104 to be activated.

In many examples the personal devices 104 may include a wireless transceiver 112 (e.g., a BLUETOOTH module, a ZIGBEE transceiver, a Wi-Fi transceiver, an IrDA transceiver, an RFID transceiver, etc.) configured to communicate with other compatible devices. In an example, the wireless transceiver 112 of the personal device 104 may communicate data with the wireless transceiver 110 of the in-vehicle component 106 over a wireless connection 114. In another example, a wireless transceiver 112 of a wearable personal device 104 may communicate data with a wireless transceiver 112 of a mobile personal device 104 over a wireless connection 114. The wireless connections 114 may be a Bluetooth Low Energy (BLE) connection, but other types of local wireless connection 114, such as Wi-Fi or Zigbee may be utilized as well.

The personal devices 104 may also include a device modem configured to facilitate communication of the personal devices 104 with other devices over a communications network. The communications network may provide communications services, such as packet-switched network services (e.g., Internet access, voice over internet protocol (VoIP) communication services), to devices connected to the communications network. An example of a communications network may include a cellular telephone network. To facilitate the communications over the communications network, personal devices 104 may be associated with unique device identifiers (e.g., mobile device numbers (MDNs), Internet protocol (IP) addresses, identifiers of the device modems, etc.) to identify the communications of the personal devices 104 over the communications network. These personal device 104 identifiers may also be utilized by the in-vehicle component 106 to identify the personal devices 104.

The vehicle component interface application 118 may be an application installed to the personal device 104. The vehicle component interface application 118 may be configured to facilitate vehicle occupant access to features of the in-vehicle components 106 exposed for networked configuration via the wireless transceiver 110. In some cases, the vehicle component interface application 118 may be configured to identify the available in-vehicle components 106, identify the available features and current settings of the identified in-vehicle components 106, and determine which of the available in-vehicle components 106 are within proximity to the vehicle occupant (e.g., in the same zone 108 as the location of the personal device 104). The vehicle component interface application 118 may be further configured to display a user interface descriptive of the available features, receive user input, and provide commands based on the user input to allow the user to control the features of the in-vehicle components 106. Thus, the system 100 may be configured to allow vehicle occupants to seamlessly interact with the in-vehicle components 106 in the vehicle 102, without requiring the personal devices 104 to have been paired with or be in communication with a head unit of the vehicle 102.

The system 100 may use one or more device location-tracking techniques to identify the zone 108 in which the personal device 104 is located. Location-tracking techniques may be classified depending on whether the estimate is based on proximity, angulation or lateration. Proximity methods are “coarse-grained,” and may provide information regarding whether a target is within a predefined range but they do not provide an exact location of the target. Angulation methods estimate a position of the target according to angles between the target and reference locations. Lateration provide an estimate of the target location, starting from available distances between target and references. The distance of the target from a reference can be obtained from a measurement of signal strength 116 over the wireless connection 114 between the wireless transceiver 110 of the in-vehicle component 106 and the wireless transceiver 112 of the personal device 104, or from a time measurement of either arrival (TOA) or difference of arrival (TDOA).

One of the advantages of lateration using signal strength 116 is that it can leverage the already-existing received signal strength indication (RSSI) signal strength 116 information available in many communication protocols. For example, iBeacon uses the RSSI signal strength 116 information available in the Bluetooth Low-Energy (BLE) protocol to infer the distance of a beacon from a personal device 104 (i.e. a target), so that specific events can be triggered as the personal device 104 approaches the beacon. Other implementations expand on the concept, leveraging multiple references to estimate the location of the target. When the distance from three reference beacons are known, the location can be estimated in full (trilateration) from the following equations:

d₁²=(x−x₁)²+(y−y₁)²+(z−z₁)²

d₂²=(x−x₂)²+(y−y₂)²+(z−z₂)²

d₃²=(x−x₃)²+(y−y₃)²+(z−z₃)² (1)

In an example, as shown in FIG. 1C, an in-vehicle component 106-B may broadcast or otherwise send a request for signal strength 116 to other in-vehicle components 106-A and 106-C of the vehicle 102. This request may cause the other in-vehicle components 106-A and 106-C to return wireless signal strength 116 data identified by their respective wireless transceiver 110 for whatever devices they detect (e.g., signal strength 116-A for the personal device 104 identified by the wireless transceiver 110-A, signal strength 116-C for the personal device 104 identified by the wireless transceiver 110-C). Using these signal strengths 116-A and 116-C, as well as signal strength 116-B determined by the in-vehicle component 106-B using its wireless transceiver 110-B, the in-vehicle component 106-B may use the equations (1) to perform trilateration and locate the personal device 104. As another possibility, the in-vehicle component 106 may identify the personal device 104 with the highest signal strength 116 at the in-vehicle component 106 as being the personal device 104 within the zone 108 as follows:

$$Personal Device = i ⇒ {max}_{i = 1 , n} {RSSl}_{i} \qquad ( 2 )$$

Thus, the mesh of in-vehicle components 106 and the personal devices 104 may accordingly be utilized to allow the in-vehicle components 106 to identify in which zone 108 each personal device 104 is located.

To enable tracking of personal devices 104 within the vehicle 102, information descriptive of the location (e.g., zone 108) of each in-vehicle component 106 relative to the vehicle 102 interior may be to be broadcast by the in-vehicle components 106 to the other in-vehicle components 106 and personal devices 104. Moreover, to provide status information indicative of the current settings of the in-vehicle components 106, the in-vehicle components 106 may also broadcast status information and/or information indicative of when changes to the settings of the in-vehicle components 106 are made.

The vehicle component interface application 118 executed by the personal device 104 may be configured to scan for and update a data store of available in-vehicle components 106. As some examples, the scanning may be performed periodically, responsive to a user request to refresh, or upon activation of the vehicle component interface application 118. In examples where the scanning is performed automatically, the transition from vehicle 102 to vehicle 102 may be seamless, as the correct set of functionality is continuously refreshed and the user interface of the vehicle component interface application 118 is updated to reflect the changes.

In an example, advertising packets in broadcasting mode may be used to communicate location, event, or other information from the in-vehicle components 106 to the personal devices 104. This may be advantageous, as the personal devices 104 may be unable to preemptively connect to each of the in-vehicle components 106 to receive component information and status updates. In an example, the advertisements may be BLE advertisements, and location, component type, and event information may be embedded into the primary service universally unique identifier (UUID) that is included in the advertisement packet made by the in-vehicle component 106. By parsing the service UUIDs of the advertisement data of the in-vehicle component 106, personal devices 104 and other in-vehicle components 106 scanning for advertisements may be able to: (i) identify the existence in the vehicle 102 of the in-vehicle component 106, (ii) determine its location and zone 108 within the vehicle 102, and (iii) detect whether a physical interaction has taken place between a user and the in-vehicle component 106 (e.g., when changes are identified to the advertised data).

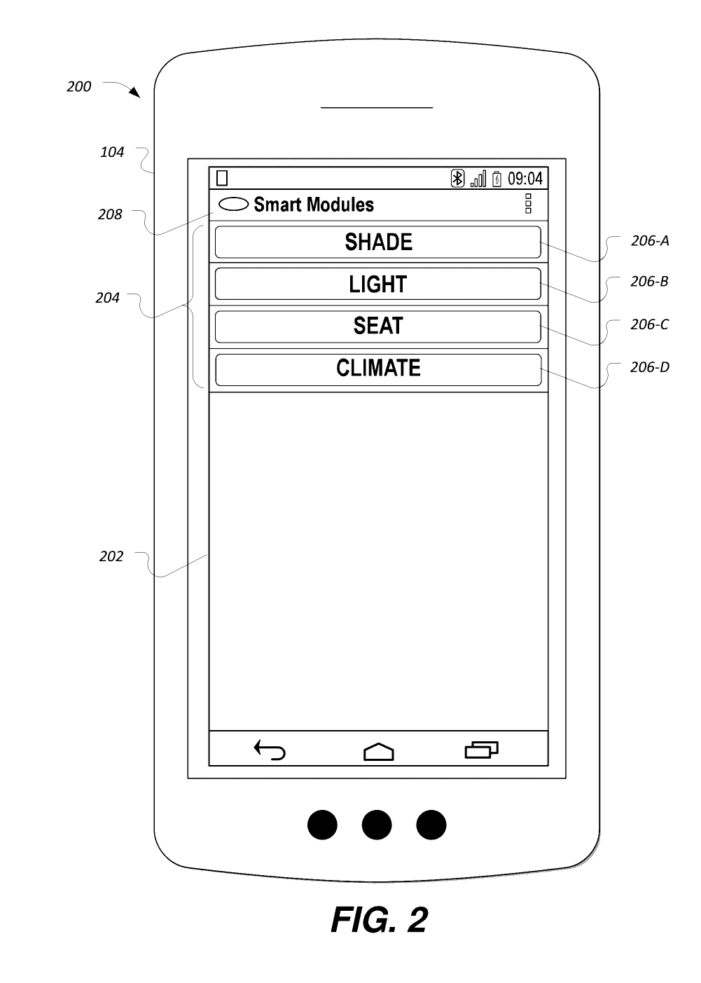

FIG. 2 illustrates an example user interface 200 of the vehicle component interface application 118 illustrating in-vehicle components 106 detected by the personal device 104. As shown, the user interface 200 may be presented by the vehicle component interface application 118 on a display 202 of the personal device 104. The presented user interface 200 may include a listing 204 configured to display selectable list entries 206-A through 206-D (collectively 206) indicative of the identified in-vehicle components 106. Each of the selectable list entries 206 may indicate a detected in-vehicle component 106 type available for configuration by the user (e.g., within the zone 108 in which the personal device 104 of the user is located). The user interface 200 may also include a title label 208 to indicate to the user that the user interface 200 is displaying a menu of in-vehicle components 106 as detected by the vehicle component interface application 118.

As illustrated, the listing 204 of the vehicle component interface application 118 includes an entry 206-A for a shade in-vehicle component 106, an entry 206-B for a light in-vehicle component 106, an entry 206-C for a seat in-vehicle component 106, and an entry 306-D for a climate control in-vehicle component 106. The listing 204 may operate as a menu, such that a user of the user interface 200 may be able to scroll through list entries of the list control 204 (e.g., using up and down arrow buttons and a select button to invoke a selected menu item). In some cases, the list control 204 may be displayed on a touch screen such that the user may be able to touch the list control 204 to select and invoke a menu item. As another example, the user interface 200 may support voice command selection of the menu items. For example, to invoke the options of the light in-vehicle component 106, the user may speak the voice command “LIGHT.” It should be noted that the illustrated entries 206 are merely examples, and more or different in-vehicle components 106 may be available. Thus, the personal device 104 can be used as an extension of the user interface of the vehicle 102.

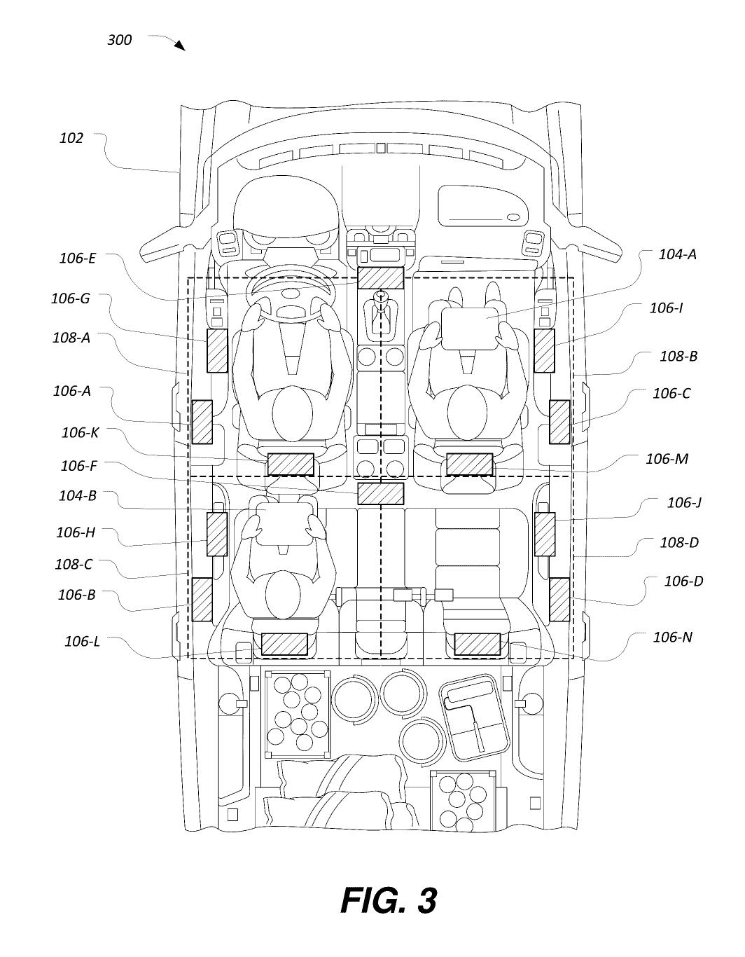

FIG. 3 illustrates an example diagram 300 including a passenger traveling in a back seat of the vehicle 102 having a personal device 104-B. For instance, the personal device 104-B may be identified as located within the zone 108-C according to triangulation with the mesh of in-vehicle components 106. The personal device 104-B may further identify the interior features available in the zone 108-C in which the personal device 104-B is located according to BLE or other advertisements. As illustrated in the diagram 300, a light in-vehicle components 106-B, a climate control in-vehicle component 106-F, a seat control in-vehicle component 106-H, and a speaker in-vehicle component 106-L are available to the personal device 104-B in the zone 108-C seating position.

The personal device 104-B of the user may receive notifications and events. In response to receipt of notifications or events, the personal device 104-B may route the notifications and events to or more of the in-vehicle components 106 of the zone 108-C in which the personal device 104-B is located. In an example, the personal device 104-B may receive an indication of an incoming communication, such as a call request, a SMS text message, an instant message, or another communication, such as comment being added a posting made by the user of the personal device 104-B. In another example, the personal device 104-B may identify an upcoming event as identified by the personal device 104-B, such as a reminder of an upcoming appointment in the user's calendar.

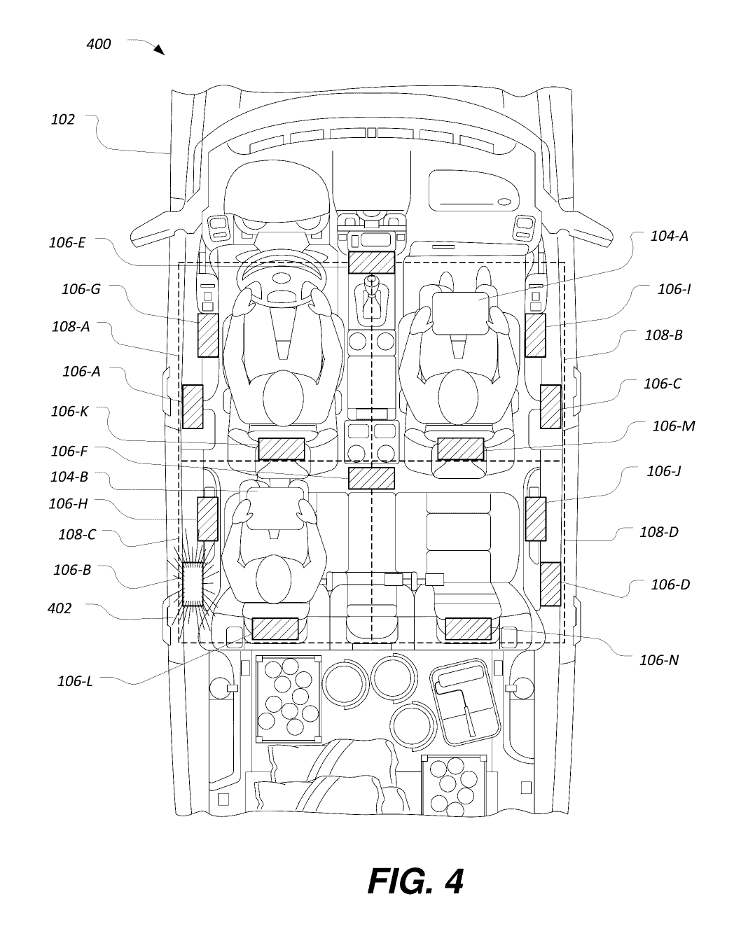

FIG. 4 illustrates an example diagram 400 illustrating a notification 402 being provided to the passenger traveling in the back seat of the vehicle 102 having the personal device 104-B. As shown, an incoming communication to the personal device 104-B may trigger a notification 402 including an activation of the interior light 106-B of the zone 108-C in which the personal device 104-B is located. The notification 402 may include, for example, activating the interior light 106-B, pulsing the interior light 106-B, blinking the interior light 106-B in a predetermined pattern, and/or changing the color of light provided by the interior light 106-B, as some non-limiting possibilities.

It should be noted that using light to perform the notification 402 is merely one possibility. As another example, a text-to-speech version of a text message received to the personal device 104-B may be routed through the speaker in-vehicle component 106 of the user's zone 108 (e.g., the speaker in-vehicle component 106-L of zone 108-C). As a further example, the contents of the test message or a notification of the text message may be visually routed to a display in-vehicle component 106 within the user's zone 108. As yet another possibility, the incoming communication to the personal device 104-B may trigger a haptic feedback sensor integrated into the seating location of the user's zone 108. Different pulsing patterns, ambient lighting colors and/or pulse modulations, as well as different seat vibration patterns, could be used to convey different type of events, such as to distinguish, for example, appointment or other calendar event reminders from incoming communications that may require more immediate action.

As mentioned above, the personal device 104-B may identify what in-vehicle components 106 features are available in the current zone 108 according to the advertisements of the in-vehicle components 106. Accordingly, the personal device 104-B may determine what types of in-vehicle components 106 within the zone 108 are available for use in providing the notification 402.

The personal device 104-B may maintain user settings indicative of the user preferences for notification 402. Accordingly, the personal device 104-B may select from the available in-vehicle components 106 to provide feedback to the user based on the available features and personal preferences. In an example, the notification preferences of the user may specify for the user to receive audio alerts of text messages if a speaker in-vehicle component 106 is available, and may otherwise prefer to receive a haptic alert, if available. In another example, the notification preferences of the user may specify for the user to receive light feedback if lighting in-vehicle components 106 are available in the zone 108 of the user. In some examples, the personal device 104-b may maintain a first set of preferences for notification of the user of incoming communications, and a second set of preferences for notification of the user of upcoming events.

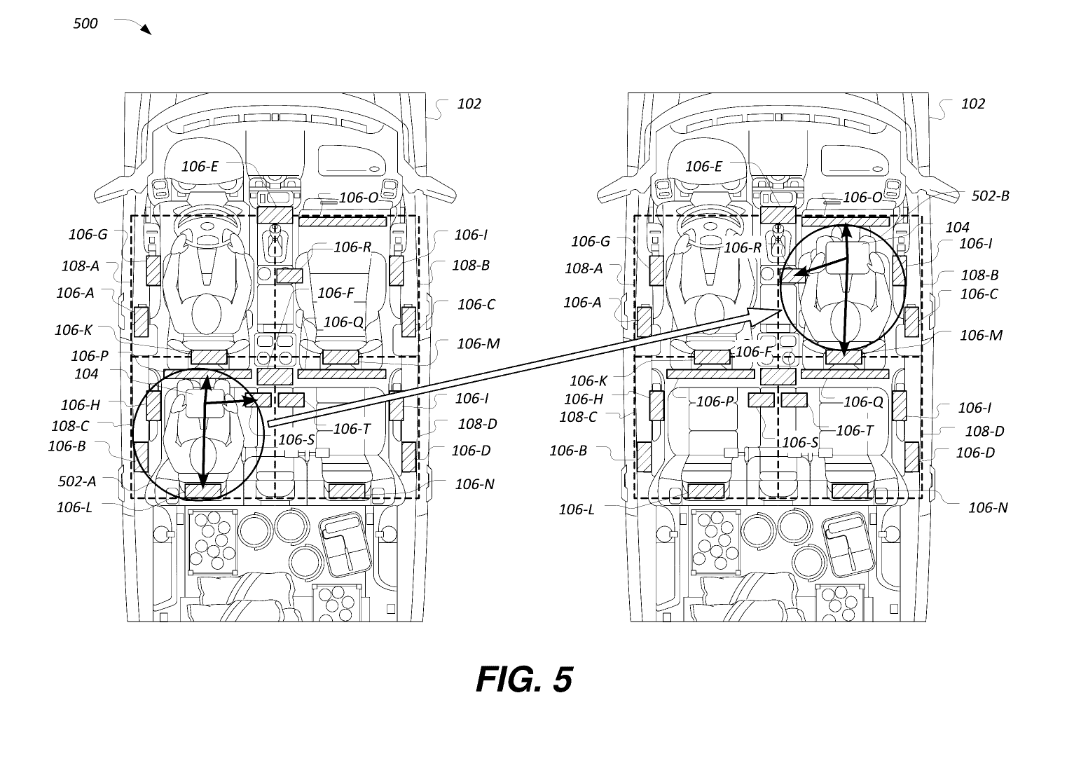

FIG. 5 illustrates an example diagram 500 of an automated connection and augmenting of the user interface of a personal device 104. The augmenting may be performed using the in-vehicle components 106 available in the zone 108 of the personal device 104. As shown, the in-vehicle components 106 in the diagram 500 include overhead light in-vehicle components 106-A through 106-D, climate control in-vehicle components 106-E and 106-F, seat control in-vehicle components 106-G through 106-J, speaker in-vehicle components 106-K through 106-N, display screen in-vehicle components 106-O through 106-Q, and keyboard in-vehicle components 106-R through 106-T. In the illustrated example diagram 500, display and keyboard in-vehicle components 106 are available in the passenger zones 108 (e.g., zones 108-B, 108-C, 108-D), but not in the driver zone 108-A.

Using the in-vehicle components 106, the personal device 104 may be able to provide an augmented user interface 502 more resembling that of a personal computer, with improved input/output functionality as compared to the native user interface of the personal device 104. For example, the display in-vehicle component 106 may be used to provide a larger, more readable, display to the personal device 104; the keyboard in-vehicle component 106 may be used to provide a larger, easier to use, input interface to the personal device 104; and the speaker in-vehicle component 106 may be used to provide a louder, higher fidelity, audio output from the personal device 104 than would be provided by the personal device 104 itself. As one possibility, the display in-vehicle component 106 may mirror the display of the personal device 104, the speaker in-vehicle component 106 may mirror a sound output of a speaker of the personal device 104, and the keyboard in-vehicle component 106 may mirror the function of an input device of the personal device 104.

In some examples, the user may transition from one zone 108 of the vehicle 102 to another zone 108 of the vehicle 102. For instance, the user may transition from the zone 108-C in the back seat to the zone 108-B of the front seat of the vehicle 102. Signal strength 116 information between the personal device 104 and the in-vehicle components 106 may be utilized to detect the transition of location of the personal device 104. Responsive to the detection of the change in zone 108 of the user, the personal device 104 may disconnect from the in-vehicle components 106 that are provided the augmented user interface 502-A of the personal device 104 in the zone 108-C, detect the in-vehicle components 106 that are in the new zone 108-B, connect to the in-vehicle components 106 of the new zone 108-B, and resume the augmentation of the user interface in the augmented user interface 502-B of the zone 108-B. From the perspective of the user of the personal device 104, the augmented user interface 502 may be seamlessly transferred to the new seating zone 108 location.

It should be noted that in some examples, automated connection to the in-vehicle components 106 (e.g., via classic BLUETOOTH and/or Wi-Fi) may involve the use of password or other connection information provided to the personal device 104. In an example, to connect to a keyboard in-vehicle component 106, the personal device 104 may require a BLUETOOTH pairing code of the keyboard in-vehicle component 106. In another example, to connect to a display in-vehicle component 106, the personal device 104 may require a media access control (MAC) address and/or an IP address of the display in-vehicle component 106. In yet a further example, to connect to a network Wi-Fi hotspot provided by the vehicle 102, the personal device 104 may require a passcode.

It may be cumbersome for a user to be required to pair with and/or enter security information for each different in-vehicle component 106 of the vehicle 102 or zone 108 that the user may enter. Accordingly, the personal device 104 may utilize an automatic credential sharing mechanism that provides the required pairing or security information to the personal device 104 without manual user entry of the information. For instance, each zone 108 of the vehicle 102 may include an in-vehicle component 106 assigned to support the credential sharing function. This in-vehicle component 106 may be a dedicated component for the purpose of credential sharing. In other example, this in-vehicle component 106 may be an in-vehicle component 106 within the zone 108 that has another function (e.g., a light), that does not require additional credentials for connection (e.g., that may be connected to over BLE without credentials).

The credential sharing function of the in-vehicle component 106 may be triggered, for example, responsive to a user pressing a button of the in-vehicle component 106. As another possibility, the credential sharing function may be triggered in response to proximity of the user to a proximity sensor of the in-vehicle component 106. An example proximity sensor may include capacitive sensors that change in capacitive due to the presence of a user's hand. In another example, wireless signal strength 116 information from the in-vehicle component 106 may be used to determine the proximity of the personal device 104 as proxy or the presence of the user. In yet a further example, the in-vehicle component 106 may utilize a near-field communication (NFC) sensor to allow the user to tap the personal device 104 to the in-vehicle component 160 to trigger the automatic credential sharing.

Responsive to the triggering of the automatic credential sharing function of the in-vehicle component 106, the in-vehicle component 106 may send the pairing and/or other security information to the personal device 104. In another example, the triggering of the automatic credential sharing function of the in-vehicle component 106 may cause the in-vehicle component 106 to send a wireless message to the personal device 104 causing the vehicle component interface application 118 of the personal device 104 to be activated. Responsive to the activation, the vehicle component interface application 118 may programmatically request, from the in-vehicle component 106 that activated the vehicle component interface application 118, security pins, passwords, or other credentials required for connection to the augmented user interface in-vehicle components 106 of the zone 108. By using the automatic credential sharing function, as the passenger enters a zone 108 of the vehicle 102: (i) the user's personal device 104 may be identified and located; (ii) a list of available in-vehicle components 106 for the zone 108 of the personal device 104 may be acquired; (iii) connections to wireless in-vehicle components 106 within the zone 108 may be established; and (iv) the augmented user interface 502 may be enabled.

Thus, the in-vehicle components 106 of the interior of the vehicle 102 may be used to augment the user interface of the personal device 104. For example, the small screen of the personal device 104 may be mirrored on a large display screen in-vehicle component 106. An external keyboard may be paired with the personal device 104 and used for typing. The interior lighting in-vehicle components 106 and seat haptic devices may be used to notify the user of event that are received or triggered on the personal device 104.

As another possibility, the in-vehicle components 106 may be used to seamlessly turn the interior of the vehicle 102 into a movie theater augmenting the capabilities of the personal device 104. For example, if a shade in-vehicle component 106 is available in the zone 108 of the personal device 104, the shade may automatically be lowered in response to a movie application being activated on the personal device 104, the screen of the personal device 104 may be mirrored to the display in-vehicle component 106 within the zone 108, and sound may be routed to a BLUETOOTH speaker in-vehicle component 106, e.g., embedded in a headrest or seat of the zone 108, to immerse the passenger in the movie.

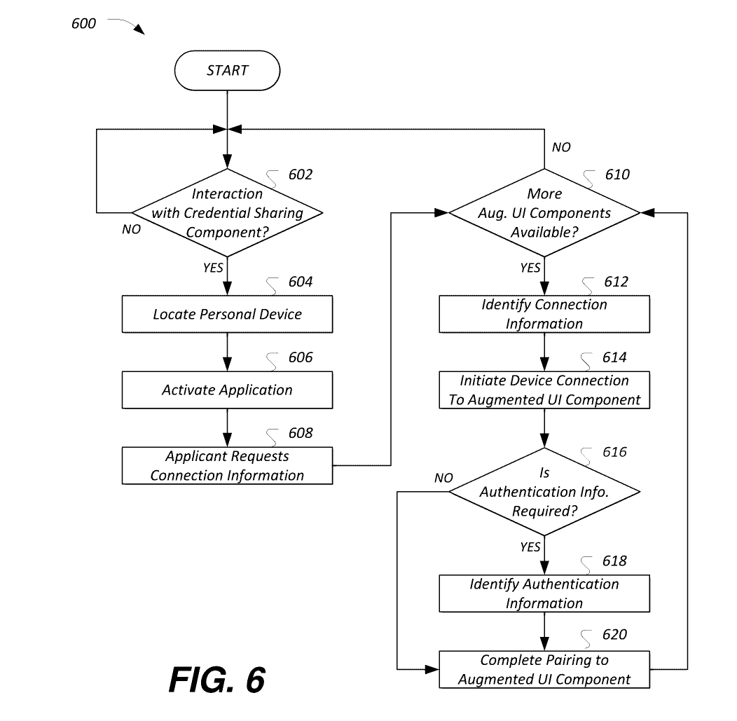

FIG. 6 illustrates an example process 600 for automatic credential sharing of information for connection of the personal device 104 to augmented user interface 502 in-vehicle components 106.

At operation 602, an in-vehicle component 106 supporting automatic credential sharing determines whether the user of the personal device 104 requests interaction. In an example, the credential sharing function of the in-vehicle component 106 may be triggered responsive to a user pressing a button of the in-vehicle component 106 requesting an augmented user interface for the personal device 104. In another example, the credential sharing function may be triggered in response to proximity of the user to a proximity sensor of the in-vehicle component 106. In yet another example, the credential sharing function may be triggered automatically in response to detection of the personal device 104 as located within a seating zone 108 of the vehicle 102.

At 604, the in-vehicle component 106 supporting automatic credential sharing locates the personal device 104 of the user. In an example, wireless signal strength 116 information from the mesh of in-vehicle components 106 may be used, by the in-vehicle component 106 supporting automatic credential sharing, to identify which personal device 104 is located in the zone 108. In yet a further example, the in-vehicle component 106 may utilize a near-field communication (NFC) sensor to allow the user to tap the personal device 104 to the in-vehicle component 106 to trigger the automatic credential sharing of operation 602 and also identify the personal device 104 of the user.

The in-vehicle component 106 activates the vehicle component interface application 118 of the personal device 104 at operation 606. In an example, the in-vehicle component 106 may send a wireless message from the wireless transceiver 110 of the in-vehicle component 106 to the wireless transceiver 112 of the personal device 104, requesting that the vehicle component interface application 118 of the personal device 104 be activated.

At 608, the in-vehicle component 106 receives a connection information request 608 from the personal device 104. In an example, responsive to its activation, the vehicle component interface application 118 may programmatically request that the in-vehicle component 106 supporting automatic credential sharing provide information regarding augmented user interface in-vehicle components 106 available within the seating zone 108.

At operation 610, the personal device 104 determines whether additional augmented user interface in-vehicle components 106 in the seating zone 108 are available to be connected. In an example, the personal device 104 may determine whether all of the available augmented user interface in-vehicle components 106 indicated by the automatic credential sharing in-vehicle component 106 have been connected to the personal device 104. If more augmented user interface in-vehicle component 106 are available, control passes to operation 612.

At 612, the personal device 104 identifies connection information from the automatic credential sharing in-vehicle component 106 that activated the vehicle component interface application 118. In an example, the vehicle component interface application 118 may programmatically request the connection information from the automatic credential sharing in-vehicle component 106. The connection information may include address information for the augmented user interface in-vehicle component 106 to be connected with the personal device 104, such as MAC address, or IP address, as some possibilities.

At operation 614, the personal device 104 initiates the connection to the augmented user interface in-vehicle component 106. For instance, the vehicle component interface application 118 may attempt connection to the augmented user interface in-vehicle component 106 according to the received connection information.

The personal device 104 determines whether authentication information is required for connection to the augmented user interface in-vehicle component 106 at operation 616. In an example, the personal device 104 may determine that such information is required based on the attempt to connect to the augmented user interface in-vehicle component 106 at operation 614. The authentication information may include, as some examples, security pins, passwords, or other credentials required for connection to the augmented user interface in-vehicle components 106 of the zone 108.

At 618, the personal device 104 identifies authentication information from the automatic credential sharing in-vehicle component 106 that activated the vehicle component interface application 118. In an example, the vehicle component interface application 118 may programmatically request the authentication information from the automatic credential sharing in-vehicle component 106.

The personal device 104 completes the pairing with the augmented user interface in-vehicle component 106 at operation 620. In an example, the personal device 104 may supply the received authentication information to the augmented user interface in-vehicle component 106. After operation 620, control passes to operation 610.

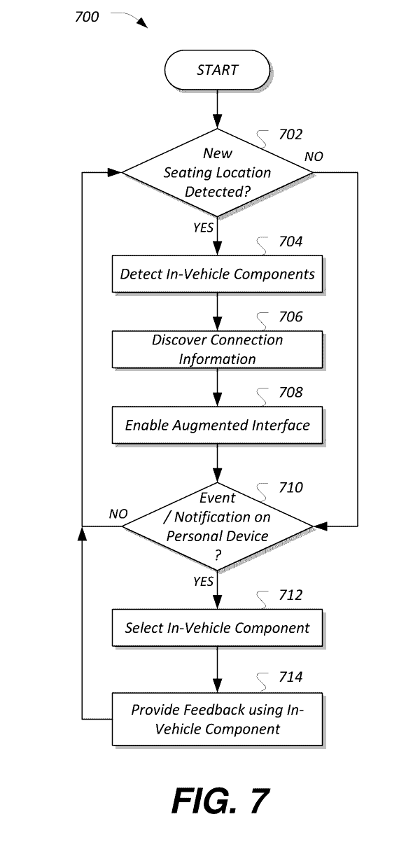

FIG. 7 illustrates an example process 700 for enabling the augmented user interface 502 in-vehicle components 106 with the personal device 104. At operation 702, the process 700 determines whether the personal device 104 is located in a new seating location of a vehicle 102. In an example, the user may transition from one zone 108 of the vehicle 102 to another zone 108 of the vehicle 102. In another example, the user may enter a zone 108 of the vehicle 102. Signal strength 116 information between the personal device 104 and the in-vehicle components 106 may be utilized to detect the transition of location of the personal device 104. In an example, the determination of a change in zone 108 may be performed by the moved personal device 104. In another example, the determination may be performed by one or more of the in-vehicle components 106 of the vehicle 102, and may be indicated to the personal device 104.

At 704, the personal device 104 detects the in-vehicle components 106 of the zone 108 of the vehicle 102. In an example, the personal device 104 may identify what in-vehicle components 106 features are available in the current zone 108 according to the advertisements of the in-vehicle components 106. At operation 706, the personal device 104 discovers connection information to the in-vehicle components 106 of the zone 108. In an example, the personal device 104 may receive the information according to the process 600 described in detail above.

The personal device 104 enables the augmented user interface 502 at operation 708. For example, a display in-vehicle component 106 in the zone 108 of the user may be used to provide a larger, more readable, display to the personal device 104; a keyboard in-vehicle component 106 in the zone 108 of the user may be used to provide a larger, easier to use, input interface to the personal device 104; and a speaker in-vehicle component 106 in the zone 108 of the user may be used to provide a louder, higher fidelity, audio functionality than would be provided by the personal device 104 itself.

At operation 710, the personal device 104 determines whether an event or notification is received to the personal device 104. In an example, the personal device 104 may receive an indication of an incoming communication, such as a call request, a SMS text message, an instant message, or another communication, such as comment being added a posting made by the user of the personal device 104. In another example, the personal device 104 may identify an upcoming event, such as a reminder of an upcoming appointment in the user's calendar.

At operation 712, the personal device 104 selects the one or more in-vehicle components 106 to perform the notification 402 of the user. In an example, based on the types of in-vehicle components 106 within the zone 108 are available for use in providing the notification 402 and user preferences indicative of the user preferences for notification 402. Accordingly, the personal device 104-B may select from the available in-vehicle components 106 to provide feedback to the user based on the available features and personal preferences. In an example, the notification preferences of the user may specify for the user to receive audio alerts of text messages if a speaker in-vehicle component 106 is available, and may otherwise prefer to receive a haptic alert, if available. In another example, the notification preferences of the user may specify for the user to receive light feedback if lighting in-vehicle components 106 are available in the zone 108 of the user. The personal device 104 provides the feedback using the one or more in-vehicle components 106 to perform the notification 402 at operation 714. After operation 714, control passes to operation 702.

Computing devices described herein, such as the personal devices 104 and in-vehicle components 106, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a personal device including
a wireless transceiver;
a memory storing preferences of a user; and
a processor, programmed to
scan, using the transceiver, for in-vehicle components of a seating zone of a vehicle in which the personal device is located,
identify available features of the in-vehicle components, and
provide feedback to the user of a notification, using at least one of the in-vehicle components, based on the preferences and the available features.

2. The system of claim 1, wherein the preferences include a first set of preferences descriptive of feedback to provide to the user when the notification is in response to receiving a communication to the personal device, and a second set of preferences descriptive of feedback to provide to the user when the notification is in response to identifying an upcoming event by the personal device.

3. The system of claim 1, wherein the processor is further programmed to identify the available features of the in-vehicle components located within the seating zone of the vehicle according to type information advertised by the in-vehicle components.

4. The system of claim 1, wherein the in-vehicle components located within the seating zone of the vehicle include a speaker in-vehicle component, and the processor is further programmed to mirror audio output of the personal device to the speaker in-vehicle component.

5. The system of claim 1, wherein the in-vehicle components located within the seating zone of the vehicle include a display in-vehicle component, and the processor is further programmed to mirror display output of the personal device to the display in-vehicle component.

6. The system of claim 1, wherein the in-vehicle components located within the seating zone of the vehicle include a keyboard in-vehicle component, and the processor is further programmed to receive user input to the keyboard in-vehicle component as user input to the personal device.

7. The system of claim 1, wherein the processor is further programmed to:
send a connection information request to one of the in-vehicle components; and
receive credentials required for access to other of the in-vehicle components responsive to the connection information request.

8. A method comprising:
identifying, by a credential sharing in-vehicle component, a user request to invoke an augmented user interface for a personal device located in a seating zone of a vehicle;
activating a component interface application of the personal device responsive to the user request; and
sending, to the component interface application, address information and authentication information of in-vehicle components in the seating zone providing the augmented user interface to the component interface application.

9. The method of claim 8, further comprising identifying the user request according to proximity of a user to a proximity sensor of the credential sharing in-vehicle component.

10. The method of claim 8, further comprising identifying the user request according to proximity of the personal device to a sensor of the credential sharing in-vehicle component.

11. The method of claim 8, wherein the address information includes at least one of a media access control address of one of the in-vehicle components providing the augmented user interface or an internet protocol address of the in-vehicle components providing the augmented user interface, and the authentication information includes a passcode for connection to the one of the in-vehicle components providing the augmented user interface.

12. The method of claim 8, further comprising providing feedback responsive to a notification to a user of the personal device using the augmented user interface based on user preferences stored to the personal device and identified features of the in-vehicle components.

13. The method of claim 12, wherein the notification is in response to receiving a communication to the personal device.

14. The method of claim 12, wherein the notification is in response to identifying an upcoming event by the personal device.

15. A non-transitory computer-readable medium embodying instructions that, when executed by a processor of a personal device, cause the personal device to:
receive, responsive to a connection information request, credentials required for access to in-vehicle components located within a seating zone of a vehicle in which the personal device is located, the in-vehicle components providing an augmented user interface to the personal device;
connect to display, speaker, and hotspot in-vehicle components of the seating zone using information included in the credentials; and
use the in-vehicle components providing the augmented user interface to send feedback to a user of a notification.

16. The medium of claim 15, further embodying instructions that, when executed by a processor of a personal device, cause the personal device to:
maintain preferences of the user of the personal device; and
send the feedback using at least one of the in-vehicle components, based on the preferences and identified features of the in-vehicle components.

17. The medium of claim 16, wherein the preferences include a first set of preferences descriptive of feedback to provide to the user when the notification is in response to receiving a communication to the personal device, and a second set of preferences descriptive of feedback to provide to the user when the notification is in response to identifying an upcoming event by the personal device.

18. The medium of claim 15, further embodying instructions that, when executed by a processor of a personal device, cause the personal device to request the augmented user interface.
